(19) United States
(12) Patent Application Publication
(10) Pub. No.: US 2024/0288067 A1
(43) Pub. Date: Aug. 29, 2024

(54) DEVICE AND METHOD FOR DETERMINING A HYDRAULIC FLUID PARAMETER OF A TRANSMISSION OF A VEHICLE

(71) Applicant: Punch Powertrain N.V., Sint-Truiden (BE)

(72) Inventors: Cláudio Filipe Semedo BRITO, Sint-Truiden (BE); Pandiaraja KUMAR, Sint-Truiden (BE)

(21) Appl. No.: 18/565,158

(22) PCT Filed: May 31, 2022
(86) PCT No.: PCT/EP2022/064752

§ 371 Date: Nov. 29, 2023

(30) Foreign Application Priority Data
May 31, 2021 (NL) 2028341

(51) Int. Cl. F16H 61/12; F16H 59/36; F16H 59/40; F16H 59/42; F16H 59/62; F16H 59/64; F16H 59/68; F16H 59/72; F16H 61/30; G01K 13/02; G01M 13/022

(52) U.S. Cl. CPC F16H 61/12; F16H 59/40; F16H 59/42; F16H 59/62; F16H 59/64; F16H 59/72; F16H 61/30; G01K 13/026; G01M 13/022; F16H 2059/366; F16H 2059/683; F16H 2061/1284

(57) ABSTRACT

Method for determining a hydraulic fluid parameter of a hydraulic clutch for a transmission of a vehicle, comprising receiving from a sensor a measurement of the hydraulic fluid parameter; receiving a further parameter different from the hydraulic fluid parameter; estimating the hydraulic fluid parameter based on at least the obtained further parameter; and comparing the received sensed hydraulic fluid parameter with the estimated hydraulic fluid parameter.

### FIELD

The invention relates to a method and a device for determining a hydraulic fluid parameter of a hydraulic fluid of a hydraulic clutch for a transmission of a vehicle.

### BACKGROUND

A hydraulic clutch of an automatic transmission of a vehicle includes a hydraulic unit for actuating the clutch. The clutch couples and decouples a motor of the vehicle with the transmission, which in turn is connected to the wheels of the vehicle. The clutch accordingly engages and disengages a power transfer from the motor via the transmission to the wheels.

The clutch is hydraulically operated using a hydraulic fluid under pressure. To monitor operation of the hydraulic unit, for example for detecting component failure or for scheduling maintenance, one or more sensors are typically arranged to measure one or more parameters of the hydraulic unit.

In case a sensor fails or malfunctions however, the operation of the hydraulic unit can no longer be monitored accurately, and as a precautionary measure, the vehicle is often stalled until the sensor is replaced or repaired, despite that the hydraulic unit could actually function properly.

### SUMMARY

It is an aim to improve the availability of the vehicle, particularly of the transmission, in case of sensor failure or malfunction.

Provided therefor is a method, in particular a computer implemented method, for determining a hydraulic fluid parameter of a hydraulic clutch for a transmission of a vehicle. The method comprises receiving from a sensor a measurement of the hydraulic fluid parameter; receiving a further parameter different from the hydraulic fluid parameter; estimating the hydraulic fluid parameter based on at least the obtained further parameter; and comparing the received sensed hydraulic fluid parameter with the estimated hydraulic fluid parameter.

Hence, the estimation of the hydraulic parameter can be used to verify the correct operation of the sensor measurement. For example, a discrepancy between the estimated and the measured hydraulic parameter may indicate a sensor malfunction. The estimated hydraulic parameter can also be used as a redundant signal, which allows the vehicle to be driven to a service station for repair or replacement of the malfunctioning senor. The hydraulic fluid may be an oil, or another liquid, e.g. a water-based liquid.

Optionally, the hydraulic parameter includes a hydraulic pressure of the hydraulic fluid. The hydraulic pressure may particularly be a hydraulic pressure at an actuation piston of a hydraulic unit, such as a clutch cylinder for operating a clutch piston. The hydraulic pressure may be indicative of an actuation force acting on the actuation piston, e.g. the clutch piston.

Optionally, the further parameter includes one or more of an electric solenoid valve current, a hydraulic pump speed, a hydraulic pump torque, a hydraulic fluid temperature, and an ambient air pressure.

Optionally, the method comprises determining a line pressure of a hydraulic circuit of the hydraulic clutch, based on a hydraulic pump speed and/or a hydraulic pump torque. The line pressure generally refers to the hydraulic pressure in the hydraulic unit applied by the hydraulic pump. It will however be appreciated that the line pressure could differ from the hydraulic pressure in the clutch cylinder, because a control valve, which could be provided in between the pump and the clutch cylinder, could apply a pressure drop over the control valve for controlling the pressure in the clutch cylinder.

Optionally, the method comprises determining force exerted on or by an electronic control valve of the hydraulic clutch for controlling a flow of the hydraulic fluid to an clutch piston, based on an electric control valve current.

Optionally, the method comprises determining a state, e.g. a position, of the control valve, based on the force exerted on or by the control valve.

Optionally, the method comprises determining a hydraulic fluid flow of the hydraulic fluid through the control valve based on the control valve state.

Optionally, the method comprises determining a pressure drop over the control valve.

Optionally, the hydraulic parameter includes a temperature of the hydraulic fluid.

Optionally, the further parameter includes one or more of an electric solenoid cooling valve current, a hydraulic pump speed, a hydraulic pump torque, a cooling pump speed, a cooling pump torque, a traction motor speed, a traction motor torque, a clutch speed, a clutch torque, a shaft speed of a transmission shaft, an engine speed of the vehicle, an engine coolant temperature, a synchronizer speed, synchronizer torque, and an ambient temperature.

Optionally, the method comprises determining a heat dissipation parameter of a traction motor of the vehicle, based on a traction motor torque and/or traction motor speed.

Optionally, the method comprises determining a heat dissipation parameter of the transmission of the vehicle, based on a speed and/or torque of one or more of an input shaft, an output shaft, an intermediate shaft, a synchronizer, of the transmission.

Optionally, the method comprises determining a heat transfer parameter between an engine coolant and the hydraulic fluid.

Optionally, the method comprises determining a heat transfer parameter between a transmission housing and components contained by the transmission housing, including one or more of a traction motor, a clutch, a synchronizer, an input shaft, an output shaft, an intermediate shaft.

Optionally, the method comprises determining a heat transfer parameter between the hydraulic fluid and components contained by the transmission housing, including one or more of a traction motor, a clutch, a synchronizer, an input shaft, an output shaft, an intermediate shaft.

Optionally, the method comprises determining a heat transfer parameter between a transmission housing and an environment of the transmission.

The method as described herein can for example be executed on a computing device, in particular on a computing device of a vehicle such as a car.

In a further aspect is provided a device which is configured and arranged for executing a method as described herein. The device, for determining a hydraulic fluid parameter of a hydraulic fluid for a hydraulic clutch of a transmission of a vehicle, comprises a sensor arranged for sensing the hydraulic fluid parameter; a receiver arranged for receiving a further parameter different from the hydraulic fluid parameter; an estimator arranged for estimating the hydraulic fluid parameter based on at least the received further parameter; and a comparator arranged for comparing the sensed hydraulic fluid parameter with the estimated hydraulic fluid parameter.

In a further aspect is provided a transmission for a vehicle, in particular an automatic transmission, comprising a clutch; a hydraulic unit for operating the clutch; and a device as described herein.

Optionally, the hydraulic unit comprises a hydraulic pump for pumping the hydraulic fluid through a hydraulic circuit of the hydraulic unit, wherein the device is arranged to estimate a line pressure of the hydraulic circuit, based on a hydraulic pump speed and/or a hydraulic pump torque.

Optionally, the hydraulic unit comprises an electric control valve, e.g. a solenoid valve, for controlling a flow of the hydraulic fluid to a clutch piston for actuating the clutch, wherein the device is arranged for determining a force exerted on or by the electronic control valve based on an electric control valve current.

Optionally, the device is arranged for determining a state, e.g. a position, of the control valve, based on the force exerted on or by the control valve.

Optionally, the device is arranged for determining a hydraulic fluid flow of the hydraulic fluid through the control valve based on the control valve state.

Optionally, the device is arranged for determining a pressure drop over the control valve.

Optionally, the transmission comprises a traction motor, wherein the device is is arranged for determining a heat dissipation parameter of the traction motor, based on a torque and/or speed of the traction motor.

Optionally, the device is arranged for determining a heat dissipation parameter of the transmission of the vehicle, based on a speed and/or torque of one or more of an input shaft, an output shaft, an intermediate shaft, a synchronizer, of the transmission.

Optionally, the device is arranged for determining a heat transfer parameter between an engine coolant and the hydraulic fluid.

Optionally, the transmission includes a transmission housing, wherein the device is arranged for determining a heat transfer parameter between a transmission housing and one or more components contained by the transmission housing, for example including one or more of a traction motor, a clutch, a synchronizer, an input shaft, an output shaft, an intermediate shaft.

Optionally, the device is arranged for determining a heat transfer parameter between the hydraulic fluid and components contained by the transmission housing, including one or more of a traction motor, a clutch, a synchronizer, an input shaft, an output shaft, an intermediate shaft.

Optionally, the device is arranged for determining a heat transfer parameter between a transmission housing and an environment of the transmission.

It will be appreciated that all features and options mentioned in view of the method apply equally to the device, and vice versa. It will also be clear that any one or more of the above aspects, features and options can be combined.

### BRIEF DESCRIPTION OF THE DRAWINGS

Embodiments of the present invention will now be described in detail with reference to the accompanying drawings in which:

FIG. 1 shows a schematic representation of a hydraulic unit for a transmission of a vehicle;

FIG. 2 shows a schematic representation of a method for estimating a hydraulic parameter;

FIG. 3 shows a schematic representation of a method for estimating a hydraulic parameter;

FIG. 4 shows a schematic representation of a heat transfer model.

### DETAILED DESCRIPTION

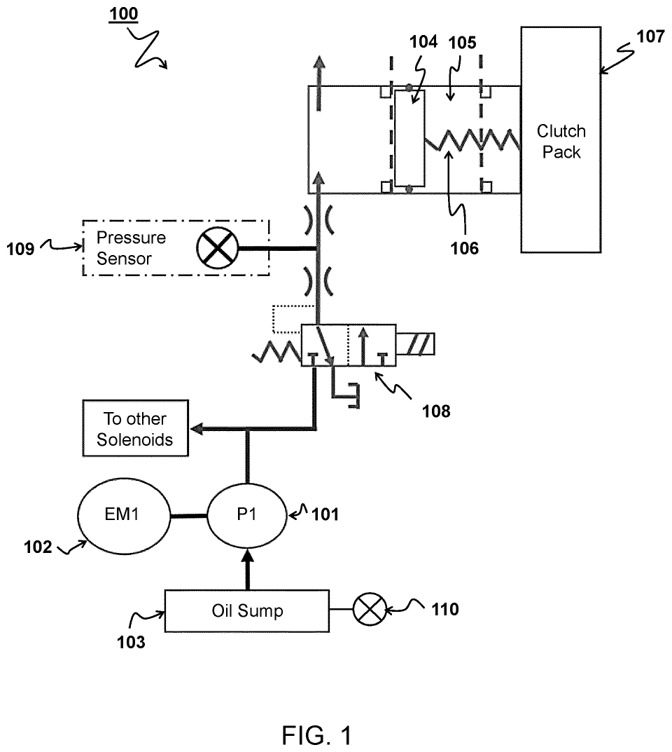

FIG. 1 schematically shows a part of a hydraulic unit 100 for a transmission of a vehicle, comprising a hydraulic pump 101, driven by a pump motor 102. The pump 101 pumps a hydraulic fluid from a sump 103 through a hydraulic circuit. In this case, the hydraulic fluid is an oil, but it will be appreciated that another hydraulic fluid can be used instead, such as water based fluids. The hydraulic unit 100 operates a clutch piston 104 which is movably arranged in a clutch cylinder 105. The clutch piston 104 is coupled to a clutch 107, here by a coupling member 106. The clutch 107 is in this case a clutch pack, comprising multiple friction plates. The clutch 107 is operated by pressurizing the cylinder 105 with the hydraulic fluid using the pump 102, so as to exert a force on the clutch piston 104, and move the clutch piston 104 within the cylinder 105. The piston 104 in turn activates the engagement of the friction plates of the clutch 107, to obtain a rigid coupling between an input and output of the clutch 107.

In this example, the transmission is an automatic transmission, particularly a dual clutch transmission. The transmission thus includes multiple clutches, of which FIG. 1 only shows a single clutch for simplicity. The clutches are automatically controlled by a control unit. The hydraulic unit 100 may include a single common sump 103. Each clutch may have a respective pump associated therewith.

In the hydraulic circuit, between the pump 101 and the cylinder 105, an electronic control valve 108 is arranged. The control valve 108 may be electronically controlled. In this example, the control valve is a solenoid valve. The control valve 108 controls a flow of hydraulic fluid to and/or from the cylinder. The control valve 108 can thus be used for controlling the pressure in the cylinder 105, and accordingly the operation of the clutch 107. The control vale, e.g. the solenoid valve, is controlled by the control unit.

A sensor is provided for measuring a hydraulic fluid parameter of the hydraulic fluid. The sensor may communicate with the control unit. In this example, a pressure sensor 109 is arranged for measuring a pressure of the hydraulic fluid. The pressure sensor 109 is arranged between the control valve 108 and the cylinder 105. The pressure sensor 109 is thus arranged for measuring the hydraulic pressure in the cylinder 105. Additionally, a temperature sensor 110 is provided for measuring a temperature of the hydraulic fluid. The temperature sensor 110 is arranged at or near the sump 103.

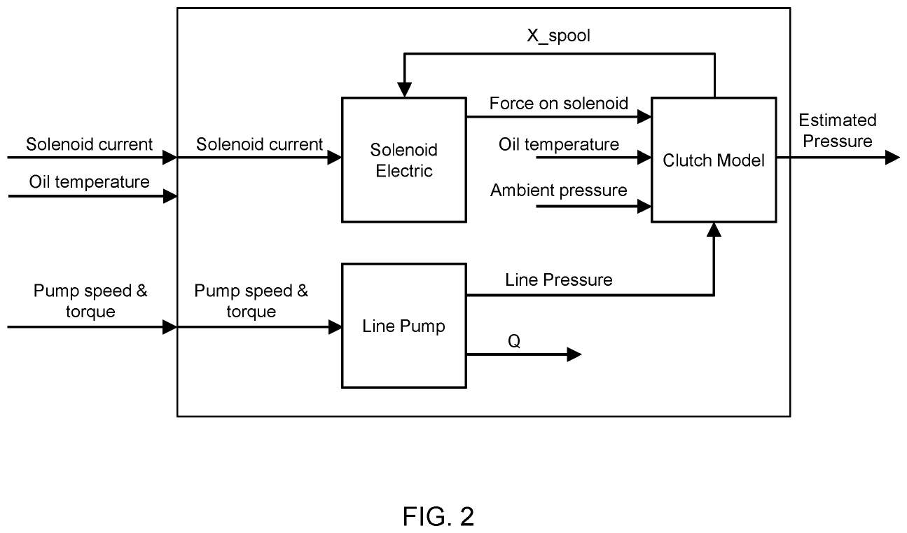

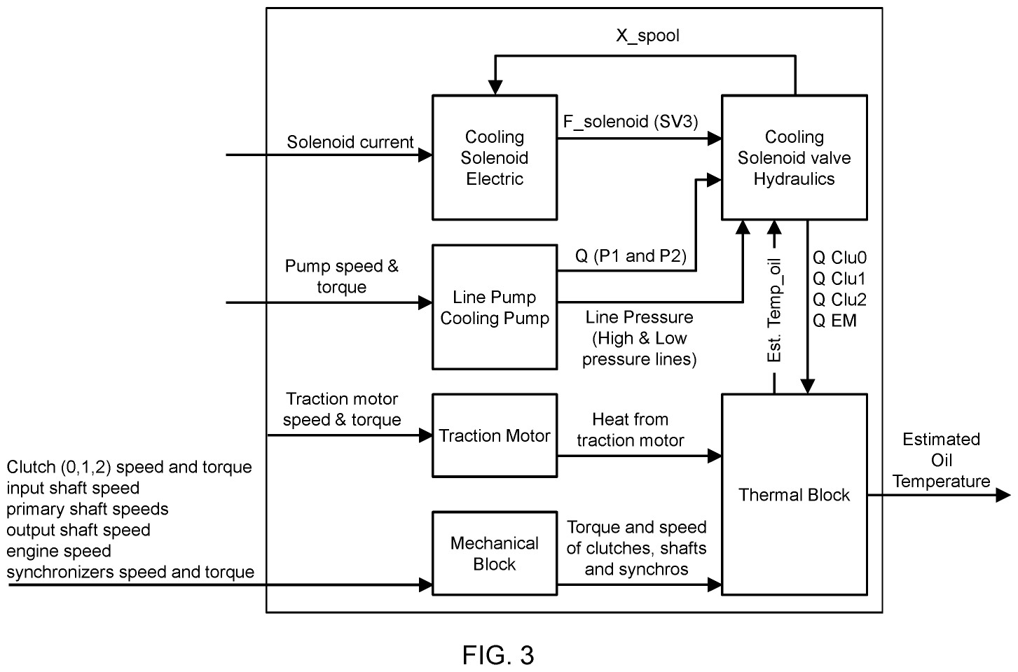

FIGS. 2 and 3 schematically show a method for estimating a hydraulic parameter of the hydraulic fluid. FIG. 2 particularly shows a schematic representation of a method for estimating a hydraulic pressure of the hydraulic fluid in the clutch cylinder 105. FIG. 3 particularly shows a schematic representation of a method for estimating a temperature of the hydraulic fluid. The estimated hydraulic fluid parameter may be used as a redundant signal. For example, in case the pressure senor 109 fails, the estimated hydraulic pressure may instead be used as a substitute for the measurement. Similarly, in case the temperature senor 110 fails, the estimated temperature of the hydraulic fluid may instead be used as an indication for the temperature of the hydraulic fluid. Also, the estimated hydraulic parameter can be used to verify the operation of the sensors.

It will be appreciated that the hydraulic parameter is particularly estimated without using measurements from said hydraulic parameter. For example, the hydraulic pressure is estimated without using a pressure measurements from the pressure sensor 109.

FIG. 2 shows in particular that hydraulic pressure is estimated based on further parameters that include an electric solenoid valve current, a hydraulic pump speed, a hydraulic pump torque, a hydraulic fluid temperature, and an ambient air pressure. Using a model of the hydraulic pump 101, a line pressure of a hydraulic circuit of the hydraulic clutch is determined based on the hydraulic pump speed and torque. It will be appreciated that the line pressure could differ from the hydraulic pressure in the cylinder 105, because the control valve 108, in between the pump 101 and the cylinder 105, could bring about a pressure drop for controlling the pressure in the cylinder 105. Further, a model of the control valve 108, here a solenoid valve, is used to determine a force exerted on or by an electronic control valve 108 based on the electric control valve current. The determined force exerted on or by an electronic control valve 108, as well as the determined hydraulic line pressure are inputted to a clutch model which includes a model of the clutch piston 104 and clutch cylinder 105. Also inputted to this model are the ambient pressure, and temperature of the hydraulic fluid. Using the clutch model, a state, e.g. a position, of the control valve 108 is determined. Based on the state of the control valve 108 a hydraulic fluid flow of the hydraulic fluid through the control valve 108 is determined. Based on the flow a pressure drop over the control valve 108 is determined. Based on the pressure drop over the control valve 108, and the determined line pressure, the hydraulic pressure in the cylinder 105 can be determined.

FIG. 3 in particular that hydraulic pressure is estimated based on further parameters that include an electric solenoid cooling valve current, a hydraulic pump speed, a hydraulic pump torque, a cooling pump speed, a cooling pump torque, a traction motor speed, a traction motor torque, a clutch speed, a clutch torque, a shaft speed of a transmission shaft, an engine speed of the vehicle, an engine coolant temperature, a 20) synchronizer speed, synchronizer torque, and an ambient temperature. Using a model of the traction motor, a heat dissipation parameter of the traction motor of the vehicle is determined, based on a traction motor torque and/or traction motor speed. Using a model of the transmission (mechanical block), a heat dissipation parameter of the transmission of the vehicle is determined based on a speed and/or torque of one or more of an input shaft, an output shaft, an intermediate shaft, a synchronizer, of the transmission. Similar to the estimation of the hydraulic pressure, a model of the hydraulic pump 101 is used to determine a line pressure of a hydraulic circuit of the hydraulic clutch based on the hydraulic pump speed and torque. Also, a model of the control valve 108, here a solenoid valve, is used to determine a force exerted on or by an electronic control valve 108 based on the electric control valve current.

The determined heat dissipation parameters of the transmission, traction motor and cooling valve are inputted to a heat transfer model (thermal block).

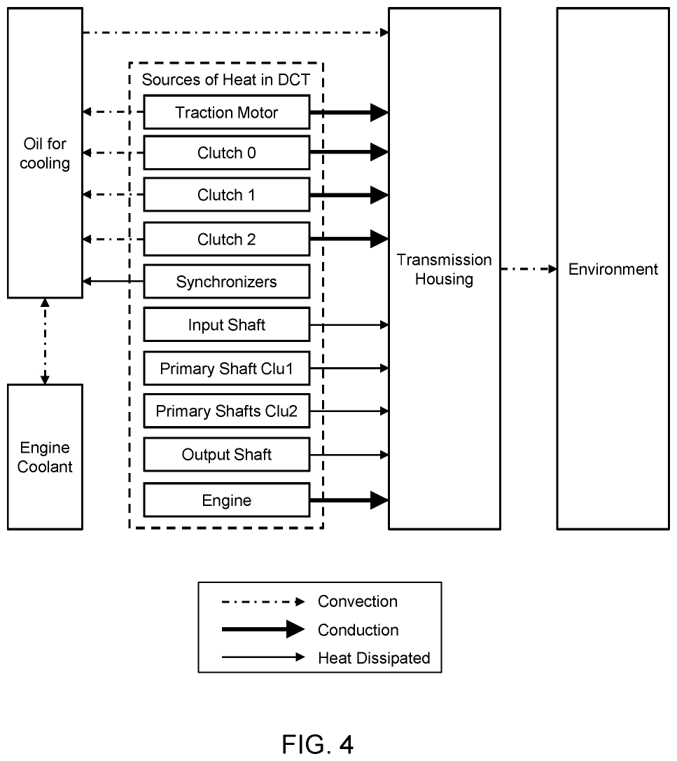

The heat transfer model (thermal block) is schematically shown in FIG. 4. Several heat transfer parameters are determined using the heat transfer model as schematically shown in FIG. 4. In particular, using the heat transfer model, a heat transfer parameter between an engine coolant and the hydraulic fluid is determined. Also, a heat transfer parameter is determined between a transmission housing and components contained by the transmission housing, including one or more of a traction motor, a clutch, a synchronizer, an input shaft, an output shaft, an intermediate shaft. Further, a heat transfer parameter is determined between the hydraulic fluid and components contained by the transmission housing, including one or more of a traction motor, a clutch, a synchronizer, an input shaft, an output shaft, an intermediate shaft. A heat transfer parameter between a transmission housing and an environment of the transmission is also determined. Based on the determined heat transfer parameters, a temperature of the hydraulic fluid is estimated. The estimated temperature can accordingly be compared with a measured temperature.

For the purpose of clarity and a concise description features are described herein as part of the same or separate embodiments, however, it will be appreciated that the scope of the invention may include embodiments having combinations of all or some of the features described.

In the claims, any reference sign placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A computer implemented method for determining a hydraulic fluid parameter of a hydraulic clutch for a transmission of a vehicle, comprising:
receiving from a sensor a measurement of the hydraulic fluid parameter;
receiving a further parameter different from the hydraulic fluid parameter;
estimating the hydraulic fluid parameter based on at least the obtained further parameter; and
comparing the received sensed hydraulic fluid parameter with the estimated hydraulic fluid parameter.

2. The method of claim 1, wherein the hydraulic parameter includes a hydraulic pressure of the hydraulic fluid.

3. The method of claim 2, wherein the further parameter includes one or more of an electric solenoid valve current, a hydraulic pump speed, a hydraulic pump torque, a hydraulic fluid temperature, and an ambient air pressure.

4. The method of claim 1, comprising determining a line pressure of a hydraulic circuit of the hydraulic clutch, based on a hydraulic pump speed and/or a hydraulic pump torque.

5. The method of claim 1, comprising determining force exerted on or by an electronic control valve of the hydraulic clutch, for controlling a flow of the hydraulic fluid to an clutch piston, based on an electric control valve current.

6. The method of claim 5, comprising determining a state of the control valve, based on the force exerted on or by the control valve.

7. The method of claim 6, comprising determining a hydraulic fluid flow of the hydraulic fluid through the control valve based on the control valve state.

8. The method of claim 7, comprising determining a pressure drop over the control valve.

9. The method of claim 1, wherein the hydraulic parameter includes a temperature of the hydraulic fluid.

10. The method of claim 9, wherein the further parameter includes one or more of an electric solenoid cooling valve current, a hydraulic pump speed, a hydraulic pump torque, a cooling pump speed, a cooling pump torque, a traction motor speed, a traction motor torque, a clutch speed, a clutch torque, a shaft speed of a transmission shaft, an engine speed of the vehicle, an engine coolant temperature, a synchronizer speed, synchronizer torque, and an ambient temperature.

11. The method of claim 9, comprising determining a heat dissipation parameter of a traction motor of the vehicle, based on a traction motor torque and/or traction motor speed.

12. The method of claim 9, comprising determining a heat dissipation parameter of the transmission of the vehicle, based on a speed and/or torque of one or more of an input shaft, an output shaft, an intermediate shaft, a synchronizer, of the transmission.

13. The method of claim 9, comprising determining a heat transfer parameter between an engine coolant and the hydraulic fluid.

14. The method of claim 9, comprising determining a heat transfer parameter between a transmission housing and components contained by the transmission housing, including one or more of a traction motor, a clutch, a synchronizer, an input shaft, an output shaft, an intermediate shaft.

15. The method of claim 9, comprising determining a heat transfer parameter between the hydraulic fluid and components contained by the transmission housing, including one or more of a traction motor, a clutch, a synchronizer, an input shaft, an output shaft, an intermediate shaft.

16. The method of claim 9, comprising determining a heat transfer parameter between a transmission housing and an environment of the transmission.

17. A device for determining a hydraulic fluid parameter of a hydraulic fluid for a hydraulic clutch of a transmission of a vehicle according to the method of claim 1, the device comprising:
a first sensor arranged for sensing the hydraulic fluid parameter;
a receiver arranged for receiving a further parameter different from the hydraulic fluid parameter;
an estimator arranged for estimating the hydraulic fluid parameter based on at least the received further parameter; and
a comparator arranged for comparing the sensed hydraulic fluid parameter with the estimated hydraulic fluid parameter.

18. A hydraulic unit for a hydraulic clutch system for transmission of a vehicle, comprising a hydraulic circuit including a hydraulic fluid for use in operating a clutch of the transmission; and the device according to claim 17.
